(19) United States
(12) Patent Application Publication
(10) Pub. No.: US 2005/0092975 A1
(43) Pub. Date: May 5, 2005

(54) Airplane jack

(76) Inventor: Charles J. Tarra, Sarasota, FL (US)

Correspondence Address: GIFFORD, KRASS, GROH, SPRINKLE & CITKOWSKI, P.C, PO BOX 7021, TROY, MI, 48007-7021, US

(21) Appl. No.: 10/978,148

(22) Filed: Oct. 29, 2004

Related U.S. Application Data
(60) Provisional application No. 60/516,337, filed on Oct. 31, 2003.

(51) Int. Cl. B66F 3/22

(52) U.S. Cl. 254/122

(57) ABSTRACT

A jack for servicing the landing wheels of aircraft in which a scissor jack is provided with an adaptor to fit the underside of aircraft and is so oriented that it extends equally to either side of the jack. A selected end of the adaptor is used to engage the aircraft landing gear making it possible to place either side of the jack closely adjacent a landing wheel at either side of an aircraft.

### REFERENCE TO RELATED APPLICATION(S)

This application claims priority of U.S. provisional patent application Ser. No. 60/516,337 filed Oct. 31, 2003, the entire content of which is incorporated herein by reference.

### FIELD OF THE INVENTION

This invention relates to jacks and more particularly to jacks of the scissor type adapted for use with light airplanes.

### BACKGROUND OF THE INVENTION

Small airplanes often are delayed at airports when it is necessary to repair wheels and tires of the landing gear. Maintenance requires a jack and the usual jacks available at airports are very large and cumbersome, often requiring a skilled operator. This causes delays in conducting maintenance. It would be desirable to have a simple mechanical jack that is compact for storage and transport and which is light in weight so that it can be carried on board a light airplane where weight is critical making it feasible for an aircraft operator to carry a jack and have it available when needed.

### SUMMARY OF THE INVENTION

It is an object of the invention to provide a jack which is small and compact and light in weight so that it can be transported with the maintenance tools in a light airplane fitted with either fixed or retractable landing gear.

It is another object of the invention to provide an airplane jack which can be used for maintenance on the undercarriage of light airplanes and can be placed closely adjacent to the landing wheels for desirable operation.

The objects of the invention are attained by a screw actuated scissor jack having an adapter at its upper, movable end which forms a trough having a generally semi-circular cross section and is disposed with its axes transverse to the axis extending equally to opposite sides of the jack. The adapter conforms to the underside of many light aircraft landing gear so that selected extending portions of the adapter may be used to locate the jack closely to the aircraft wheel for servicing purposes.

### DESCRIPTION OF THE DRAWINGS

FIG. 1 is a perspective view of the airplane jack embodying the invention in position relative to one of the landing gear of an aircraft;

FIG. 2 is a side elevation of the airplane jack in a raised position; and

FIG. 3 is a plan view from one end of the airplane jack in FIG. 2.

### DETAILED DESCRIPTION

The airplane jack of the present invention is designated in its entirety at 10 and includes a scissor-jack portion 12 and an adapter 14. The jack portion 12 includes a base member 16 which is intended to be placed on a firm, flat and stationary surface such as a hanger floor or apron. The base member 16 pivotally supports a pair of oppositely extending links or arms 18 and 20, from a pair of spaced pivot pins 22 extending transversely of elongated base 16. The arms 18 and 20 have channel shaped cross sections which open upwardly. The adjacent ends of arms 18 and 20 are provided with teeth 24 on each of the flanges of the channel shaped arms that are concentric with pins 22 and in mesh with each other to maintain the angles of the two arms relative to the horizontal base 16 equal to each other.

The outer end of arm 18 receives a downwardly opening channel formed by the cross section of an upwardly and inwardly extending arm 26. The arms 18 and 26 are pivoted together at the axles of a trunnion member 28. The outer ends of the oppositely-extending lower arm 20 receives an outer end of an upwardly and inwardly extending arm 30 and the two arms 20 and 30 are pivoted relative to each other by the axles of a second trunnion member 32.

The upper inner ends of arms 26 and 30 are received within a channel shaped support member 36 and are pivotally connected to the channel by a pair of spaced pins 38. The upper inner ends of arms 26 and 30 are provided with teeth 42 on each of the channel flanges and like the teeth 24 associated with the lower arms 18 and 20, act to maintain the angular relation of the upper arms relative to the horizontal channel shaped support member 36.

The upper inner ends of the arms 26 and 30 with the pivot pins 38 and channel member 36 can be positioned at various elevations relative to the base 16 by a means of a threaded shaft 46 having one end rotatable but axially fixed in the trunnion 32.

The shaft 46 is threaded over a major portion its length as indicated at 50. The threads 50 are received in an internally threaded portion of the trunnion 26. Rotational movement of the shaft 46 in opposite directions causes scissoring action of the links or arms 18, 20, 26 and 30, which have substantially equal lengths forming the four sides of a rectilinear linkage system. During such rotation of shaft 46, the trunnions 28 and 32 located at diametrically opposed corners of the linkage system move toward and away from each other. Also, the linkage system formed by arms 18, 20, 26, 32 moves in the same general vertical plane in use.

In the collapsed position of jack 12, the arms 18 and 20 lie horizontally with their channel shaped cross sections opening upwardly to receive the shaft 46. Also, the arms 26 and 30 seat within the channel shaped member 1.8 and 20 and cover the shaft 46. The resultant package is elongated and compact.

A more detailed description of such scissor-jacks can be found in U.S. Pat. Nos. 5,364,071 and 6,375,161.

The top surface of channel member 36 is provided with the adapter 14 which is semi-circular in cross section with its axis generally parallel to the pivot axes of the members and elements at 22, 28, 32 and 38. Adapter 12 is fixed as by welding to channel member 36 and forms an upwardly opening trough engagable with the underside of the curved portion of an aircraft landing gear 52.

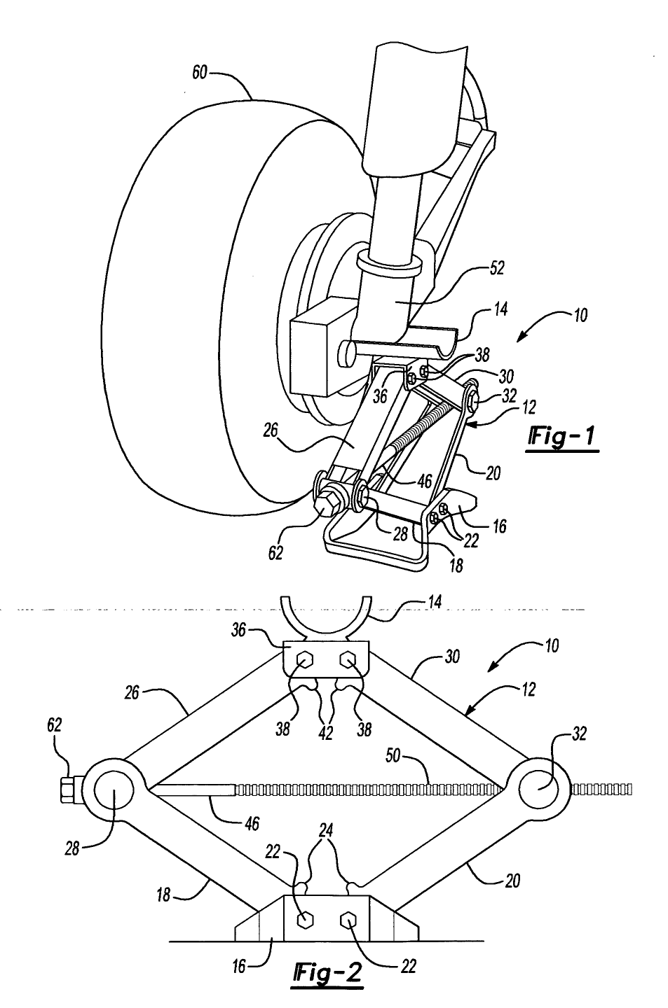

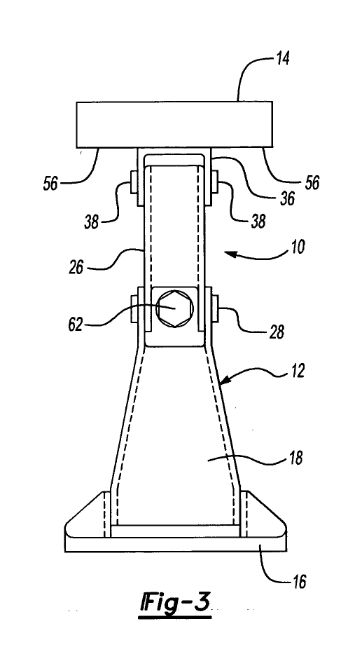

The adaptor 14 also is elongated so that it has portions 56 and 58 extending equal distances in opposite directions beyond the outer extent of the upper arms 26 and 32 as best seen in FIG. 3. The extensions 56 and 58 of the adapter 14 make it possible to position the relatively flat jack 12 close to the landing wheel 60 of an airplane, as seen in FIG. 1.

In use, the jack 12 is positioned as indicated in FIG. 1 with one extended end 56 or 58 of the adapter 40 in engagement with a lower curvilinear surface of a casting of the aircraft landing gear indicated at 52 forming part of the structure supporting one of the aircraft landing wheels 60. Such curved surfaces are common to many aircraft. By way of example, the curved surface of adapter 14 which has an internal diameter of about one and five eighths of an inch (4.1 cm) is found to be complementary to the curved surfaces of landing gear on aircraft manufactured by Piper and Beechcraft. The extensions 56 and 58 of adapter 14 permit the jack 12 to be placed closely to the inner surface of the wheel 60 so that subsequent actuation of the jack by means of a handle having a socket to receive the hexagon head 62 at the end of threaded shaft 46. Rotation of the head 62 elevates the adapter 14 and raises the wheel 60 of the aircraft for servicing. With the head 62 facing the same end of the aircraft, the jack 12 can be placed at the opposite landing gear wheel, using the opposite extended end 46 or 48 of the adapter 14 to engage the casting on the aircraft landing gear 52.

If it should become desirable to have the head 62 of shaft 46 extending toward the opposite end of the aircraft, the extension 58 is used instead of extension 56. Similarly, at the opposite side of the aircraft, the extension 56 would be used instead of extension end 58.

An aircraft jack has been provided which is relatively light and compact and can be carried with the aircraft. An actual unit was found to weigh only four and one-half pounds. The jack has an aircraft-engaging adapter which is semi-circular in cross section to mate with the typical curved structure forming the landing gear of the aircraft and extends transversely of the body of the jack so that the jack can be placed closely to the point where the aircraft must be engaged to be lifted.

1. A lift apparatus for a selected one of a pair of aircraft landing gear comprising;
a scissor jack including a pair of lower links having inner ends pivoted to a base member and outer ends pivoted to the outer ends of a pair of upper links.
A support member pivotably connected to the inner ends of said upper links;
a pair of trunnion members pivotally connecting the outer ends of said pairs of lower and upper links to each other;
an elongated screw having one portion rotatable and axially fixed in one of said trunnion members and another portion threadably engaged in the other of said trunnion members for axial movement relative thereto upon rotation of said screw, said screw being rotatable in one direction to move said trunnion members toward each other to raise said support member and in the other direction to lower said support member; and
an adaptor connected of said support member, said adapter being generally semi circular in cross section and disposed with its axis transverse to said screw and open upwardly, said adapter extending beyond the opposite sides of said scissor jack to engage a selected one of said landing gear for lifting and lowering the latter upon rotation of said screw.

2. The lift mechanism of claim 1 wherein said adapter is fixed to said support member.

3. The lift mechanism of claim 1 wherein said adaptor has end portions projecting equally beyond the opposite sides of said upper and lower links.

4. The lift mechanism of claim 3 wherein said jack is positioned in a selected one of two positions at each of said pair of aircraft landing gear with a selected one of said end portions in abutting engagement with said landing gear.

5. The lift mechanism of claim 1 wherein said links are substantially of equal length.

6. The lift mechanism of claim 1 wherein said inner ends and said outer ends of said pairs of upper and lower links form diagonally opposite corner portions of a rectilinear linkage system movable in a common plane, said adapter being disposed transverse to said plane.

7. A lift mechanism for aircraft landing gear including ground engaging wheels comprising:
a scissor jack having four equally long arms forming the sides of a rectilinear linkage system and having adjoining ends of said links pivotal relative to each other for movement of said links in the same vertical plane,
an elongated rotatable screw having one portion axially fixed at a first corner of said linkage system and another portion of said screw axially movable at a diagonally spaced second corner of said linkage system,
a ground engaging base member disposed at a third corner of said linkage system;
an elongated adapter extending transversely to said vertical plane and connected to said linkage system at a fourth corner of said linkage system, said adapter forming a generally semi-circular trough opening upwardly and projecting to opposite sides of said plane, a selected one of said projecting portions of said adapter being engageable with landing gear of aircraft, said screw being rotatable in opposite directions to move said first and second corners toward and away from each other for lifting and lowering said aircraft landing gear.

8. The lift mechanism of claim 7 wherein said propelling portions extend equally to opposite sides of said vertical plane whereby a second side of said jack is disposed adjacent a selected one of said landing gear.
